(19) United States
(12) Patent Application Publication
(10) Pub. No.: US 2010/0232306 A1
(43) Pub. Date: Sep. 16, 2010

(54) METHODS FOR SUPPORTING IPv6 USING BRIDGE EXTENSION IN WIRELESS COMMUNICATION SYSTEM

(75) Inventors: Hong-Seok Jeon, Daejeon (KR); Eun-Ah Kim, Daejeon (KR); Hee-Young Jung, Daejeon (KR); Hyeong-Ho Lee, Daejeon (KR); Jung-Hoon Jee, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/377,979

(22) PCT Filed: Aug. 17, 2007
(86) PCT No.: PCT/KR07/03947

§ 371 Date: Feb. 18, 2009

(30) Foreign Application Priority Data
Aug. 18, 2006 (KR) 10-2006-0078289
Nov. 16, 2006 (KR) 10-2006-0113453
Aug. 14, 2007 (KR) 10-2007-0081673

(51) Int. Cl. H04L 12/26; H04H 20/71; H04L 12/56

(52) U.S. Cl. 370/252; 370/312; 370/401

(57) ABSTRACT

The present invention relates to a method for supporting Internet Protocol version 6 (IPv6) in a wireless communication system. According to an exemplary embodiment of the present invention, a wireless communication system consists of an access router, a bridge, and a base station. The access router allocates a common network prefix to all subscriber stations served by it. When receiving IP multicast data destined for all nodes on the same link, the access router forwards the data back to the bridge. The bridge transmits IP multicast data with reference to an identification cache table (ICT) which includes MAC addresses of each subscriber stations, identifiers for point-to-point connections between the bridge and base station, IPv6 addresses of each subscriber station and valid flags for the IPv6 addresses. The base station provides point-to-point connections to both the bridge and each of subscriber stations.

### TECHNICAL FIELD

The present invention relates to a method for supporting Internet Protocol version 6 (IPv6) in a wireless communication system. More particularly, the present invention relates to a system for supporting IPv6 in an Ethernet-based wireless access network in which network prefix information is shared, and a supporting method thereof.

In addition, this work was supported by the IT R&D program of MIC/IITA[2005-S-025-02, the S/W Platform Development for Mobile Devices supporting Interworking between CDMA and HPi Network]

### BACKGROUND ART

Access providers may formulate a policy that all data generated from subscriber stations are forcibly transmitted to an access router functioning as a network access server (NAS) because of security and accounting issues.

In a wireless access network in which network prefix information is shared, each of subscriber stations shares the same network prefix information and IPv6 modules of the subscriber stations determine that subscriber stations sharing the same network prefix information reside on the same link. Accordingly, when a subscriber station transmits data to other subscriber stations known to reside on the same link, the subscriber station attempts to transmit the data directly to the other subscriber stations rather than to the access router. However, the policy of the access provider makes the data be sent to the access router, not directly to the other subscriber stations. For example, when a subscriber station transmits IP multicast data destined for link-local scoped all-nodes multicast address, which is transmitted to all IPv6 nodes on the same link, the IP multicast data are transmitted to the access router, the access router discards the data without forwarding, and therefore the data are not appropriately transmitted.

In addition, IPv6 neighbor discovery (ND) [RFC2461] specifies mutual operations between the IPv6 nodes on the same link. Among messages used in the IPv6 neighbor discovery, router advertisement (RA) and neighbor advertisement (NA) messages have link-local scoped all-nodes multicast address as the IP destination address.

Since the link-local scoped all-nodes multicast address indicates all IPv6 nodes on the same link, the messages are transmitted to unintended subscriber stations, which results in waking up subscriber stations in a power saving mode, and wasting radio resources and power.

### DISCLOSURE OF INVENTION

### Technical Problem

The present invention has been made in an effort to provide a system for overcoming problems with a policy of an access provider and successfully transmitting data between subscriber stations on the same link, and a method thereof.

In addition, the present invention has been made in an effort to provide a method for solving problems of radio resource waste and power consumption caused when a subscriber station transmits IP multicast data, which are transmitted to all IPv6 nodes on the same link.

### Technical Solution

According to an exemplary embodiment of the present invention,

a bridge of a wireless communication system including one sub-network includes an access router, a bridge, and a base station. The access router allocates a common network prefix to subscriber stations positioned on the same link. The bridge transmits data having a multicast address, which is transmitted to nodes positioned on the same link, as a destination address with reference to an identification cache table (ICT) having a MAC address of each subscriber station connected to the bridge, an identifier for point-to-point connection between the bridge and each subscriber station, an IP address, and a valid flag value. The base station performs point-to-point connection between the bridge and each subscriber station.

Here, when receiving the data having the multicast address, which is transmitted to the nodes positioned on the same link, as the destination address from the bridge, the access router transmits the data back to the bridge.

According to another exemplary embodiment of the present invention, in a method for supporting neighbor discovery for duplicate address detection by a bridge of a wireless communication system in which network prefix information is shared,

a) a neighbor solicitation message is received from a first subscriber station, b) it is determined whether a temporary IP address of the first subscriber station is overlapped with reference to an identification cache table (ICT) having a MAC address of each subscriber station connected to the bridge, an identifier for point-to-point connection between the bridge and each subscriber station, an IP address, and a valid flag value, c) a valid flag of the first subscriber station is inactivated when it is determined in b) that the IP address is overlapped, and a neighbor solicitation message is transmitted to a solicited node, d) a neighbor advertisement message is received from a second subscriber station using the IP address of the first subscriber station, and e) the neighbor advertisement message is transmitted through the point-to-point connection between the first subscriber station and the bridge.

In addition, f) the valid flag is activated and the neighbor solicitation message is discarded when it is determined in b) that the IP address of the first subscriber station is not overlapped.

According to a further exemplary embodiment of the present invention, in a method for transmitting a router advertisement message by a bridge of a wireless communication system in which network prefix information is shared,

a) the router advertisement message is received from an access router, b) identifier information for point-to-point connection of each subscriber station is searched from an identification cache table (ICT) having a MAC address of each subscriber station connected to the bridge, an identifier for point-to-point connection between the bridge and each subscriber station, an IP address, and a valid flag value, and c) the router advertisement message is transmitted to the corresponding subscriber station through the point-to-point connection based on the searched identifier information.

### Advantageous Effects

According to the exemplary embodiment of the present invention, a bridge controls transmission of IP multicast data in a wireless communication system sharing common network prefix information so that radio resource waste and power consumption can be reduced.

In addition, a method for supporting a multicast service may be provided since the IP multicast data are transmitted through point-to-point connections in a wireless communication network that does not support an native IP multicast service.

### BRIEF DESCRIPTION OF THE DRAWINGS

FIG. 1 is a diagram illustrating network configuration of a wireless communication system according to a first exemplary embodiment of the present invention.

FIG. 2 is a diagram illustrating network configuration of a wireless communication system according to a second exemplary embodiment of the present invention.

FIG. 3 is a diagram illustrating configuration of an extended bridge according to exemplary embodiments of the present invention.

FIG. 4 is a diagram illustrating an ICT included in a bridge in the wireless communication system according to the exemplary embodiments of the present invention.

FIG. 5 is a flowchart for generating ICT information with a neighbor solicitation message for duplicate address detection (DAD) transmitted from a subscriber station according to the exemplary embodiment of the present invention.

FIG. 6 is a flowchart for supporting neighbor discovery operations for DAD in the wireless communication system according to the exemplary embodiments of the present invention.

### BEST MODE FOR CARRYING OUT THE INVENTION

The present invention relates to a method for supporting Internet Protocol version 6 (IPv6) in a wireless communication system. More particularly, the present invention relates to a system for supporting IPv6 in an Ethernet-based wireless access network in which network prefix information is shared, and a supporting method thereof.

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word ‘comprise’, and variations such as ‘comprises’ and ‘comprising’, will be understood to imply the inclusion of stated elements but not the exclusion of any other elements. The terms ‘module’, ‘unit’, and ‘block’ used herein mean one unit that processes a specific function or operation, and may be implemented by hardware or software, or a combination thereof.

A method for supporting IPv6 using an extended bridge in a wireless communication system according to an exemplary embodiment of the present invention will now be described with reference to the figures.

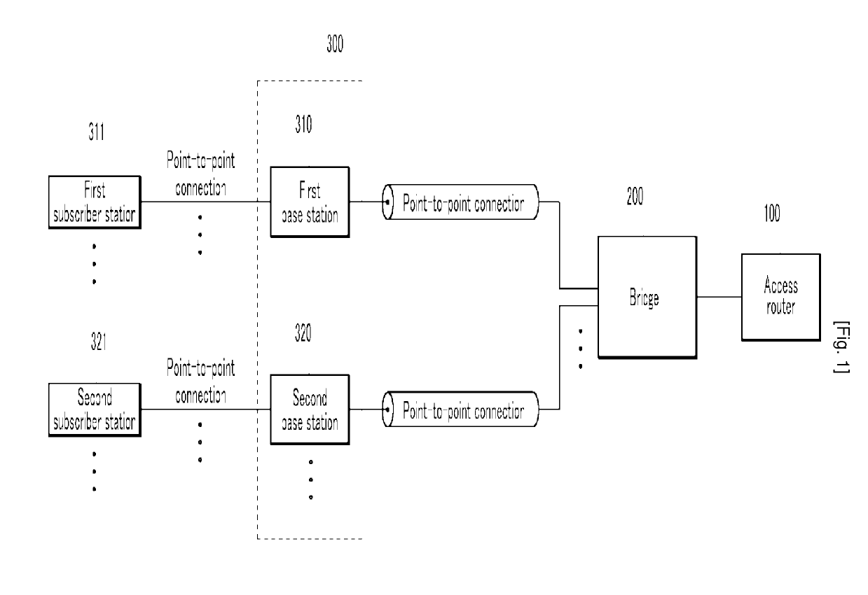

FIG. 1 is a diagram illustrating network configuration of a wireless communication system according to a first exemplary embodiment of the present invention.

As shown in FIG. 1, the wireless communication system according to the exemplary embodiment of the present invention includes an access router 100 connected to an external network, a bridge 200, and a plurality of base stations 300 connected to the bridge 200. In addition, the respective base stations are connected to a plurality of subscriber stations.

In FIG. 1, it is assumed that an access service provider has a policy of transmitting all data generated from subscriber stations to the access router 100 because of security and accounting issues.

The access router 100 has a packet relay function which forwards again the bridge 200 IP multicast data received from the bridge 200 and destined for all IPv6 nodes on the same link. In this case, the access router maintains a same source Internet Protocol (IP) address and an Hop Limit value as those of the data which have received from the bridge 200.

The base station 300 includes a plurality of first base stations 310 and second base stations 320, and provides point-to-point connections to each of subscriber stations 311, 321 and the bridge 200. For better description and convenience, it is illustrated in FIG. 1 that two individual base stations 310, 320 connect to the bridge 200 and two individual subscriber stations 311, 321 connect to two separate base stations 310, 320.

The base station 300 establishes point-to-point connections assigned to each of subscriber stations as wired link between the base station 300 and the bridge 200 as well as point-to-point connections assigned to each of subscriber stations as wireless link between the subscriber stations and the base station 300, and maintains information mapping point-to-point connections in wired link to point-to-point connections in wireless link. This aims to provide virtual point-to-point connections for each of subscriber stations between subscriber stations and the bridge 200. For example, in an IEEE 802.16 based access network, a connection identifier (CID) may be used as the identifier for point-to-point connections assigned to each of subscriber stations as wireless link between the subscriber stations and the base station 300, and a general routing encapsulation (GRE) key value or a virtual local area network (VLAN) identifier may be used as a corresponding point-to-point connection identifier when a GRE tunnel or a VLAN is used to assign each of subscriber stations a point-to-point connection between the base station 300 and the bridge 200. The base station 300 maintains mapping information for the two types of identifier information.

The bridge 200 connects the base station 300 with the access router 100, and transmits the data received from the subscriber station through the base station 300 to the access router 100. More particularly, the bridge 200 establishes each point-to-point connections for individual subscriber stations to the base station 300, and transmits data destined for the subscriber stations through the established point-to-point connections.

The bridge 200 learns that which port is belonged to a MAC address of the subscriber station with reference to a source MAC address of the received data according to an IEEE 802.1D standard. In addition, the bridge 200 supports an IGMP/MLD snooping operations specified in [RFC4541], and learns that which port is belong to a multicast group address. The aforementioned port is not a physical port provided by the bridge 200, but an identifier for the point-to-point connections assigned to each of subscriber stations between the base station 300 and the bridge 200. GRE Key or the VLAN ID can be used for the port. The bridge 200 transmits data destined for subscriber stations through the point-to-point connection corresponding to the subscriber stations.

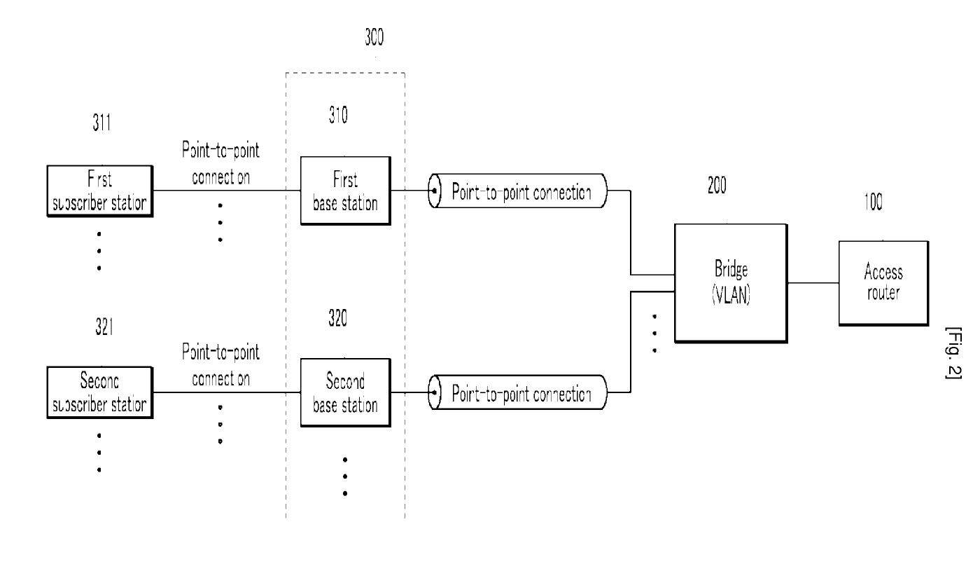

FIG. 2 is a diagram illustrating network configuration of a wireless communication system according to a second exemplary embodiment of the present invention.

Referring to FIG. 2, the network configuration shown in FIG. 2 is similar to that of FIG. 1, but communication between subscriber stations is allowed unlike FIG. 1. Accordingly, the packet relay function of the access router 100 is not required in FIG. 2.

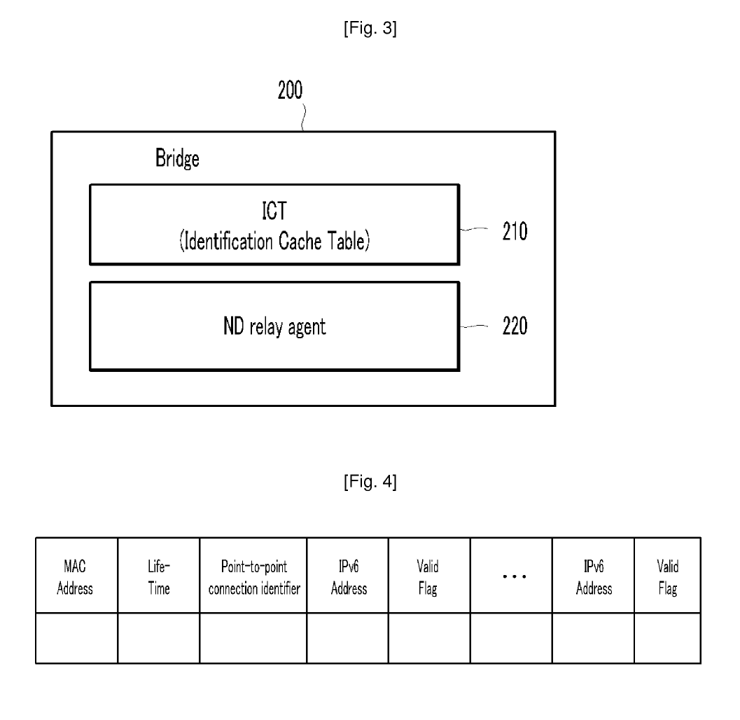

An extended bridge 200 according to the exemplary embodiments of the present invention will now be described with reference to FIG. 3 and FIG. 4.

FIG. 3 is a diagram illustrating configuration of the extended bridge according to the exemplary embodiments of the present invention.

Referring to FIG. 3, the bridge 200 includes an identification cache table (ICT) 210, a neighbor discovery relay agent 220, and extended functions for supporting an IPv6 operation.

FIG. 4 is a diagram illustrating an ICT included in the bridge in the wireless communication system according to the exemplary embodiment of the present invention.

An ICT 210 is collection of information on subscriber stations connected to the base station 300. As shown in FIG. 4, the ICT 210 includes a MAC address of a subscriber station, an identifier for point-to-point connection assigned to the subscriber station between the bridge and base station, one or a plurality of IPv6 addresses generated by the subscriber station according to [RFC2462], and valid flags for indicating a valid state of the generated IPv6 addresses.

The identifier for the point-to-point connection in the ICT 210 indicates the point-to-point connection assigned to each subscriber station between the base station 300 and the bridge 200. The point-to-point connection is created once wireless point-to-point connection is established between the subscriber station and the base station. In other words, the point-to-point connection for each subscriber station between the base station 300 and the bridge 200 may be created before IP connections for subscriber stations are established.

Each information on subscriber stations in the ICT 210 is maintained based on a life-time and thus information on a subscriber station which has no incoming or outgoing data is removed.

The neighbor discovery relay agent 220 creates an IPv6 address and a valid flag for the IPv6 address in the ICT, and controls transmission of the IP multicast data destined for all nodes based on the created information in ICT, in order to support the neighbor discovery operation.

When receiving a neighbor solicitation (NS) message for duplicate address detection (DAD) from a subscriber station, the neighbor discovery relay agent 220 creates the IPv6 address information on the subscriber station in the ICT 210 with a Tentative IP address conveyed by Target Address field in the NS message. Then, the neighbor discovery relay agent 220 determines whether the created IPv6 address is in duplicate or not, by means of looking for same IPv6 address in ICT 210 (with activated valid flag) as the created IPv6 address, and activates the corresponding valid flag when the created IPv6 address is not in duplicate. The activated valid flag indicates that the corresponding IPv6 address is unique in the ICT 210.

When determining the created IPv6 address is in duplicate, the neighbor discovery relay agent 220 inactivates the valid flag corresponding to the created IPv6 address, and forwards the NS message to a solicited node. When receiving a neighbor advertisement (NA) message indicating the temporary IPv6 address is currently used in response to the NS message, the neighbor discovery relay agent 220 refers to ICT 210 so as to find information on subscriber station which has the inactivated valid flag and IPv6 address identical to that in a Target Address field of the received NA message. In addition, the neighbor discovery relay agent 220 uses identifier for the point-to-point connection assigned to above the found subscriber station in order to transmit the NA message through the point-to-point connection.

Furthermore, when receiving periodic router advertisement (RA) messages from the access router 100, the neighbor discovery relay agent 220 in the bridge 200 transmits the RA messages through all the point-to-point connections between the base station 300 and the bridge 200 with reference to the identifier for the point-to-point connections in the ICT.

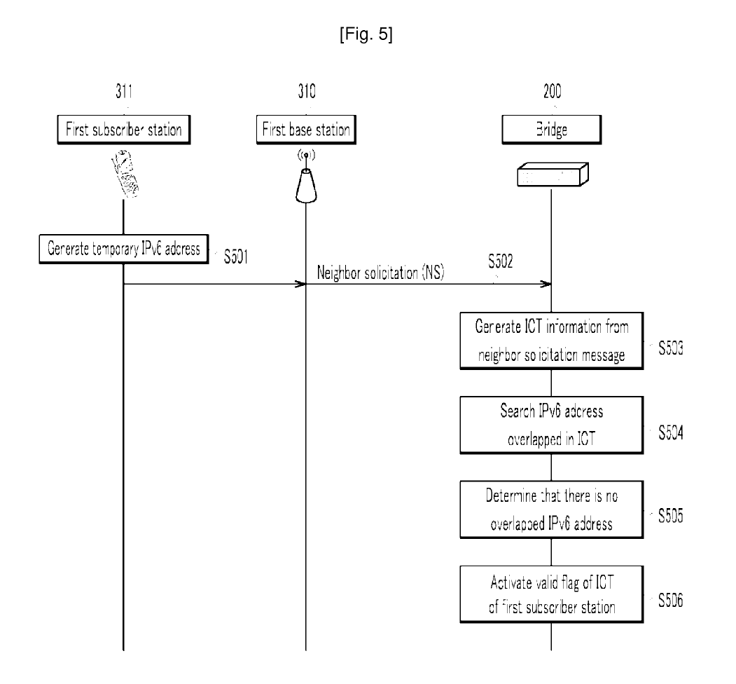

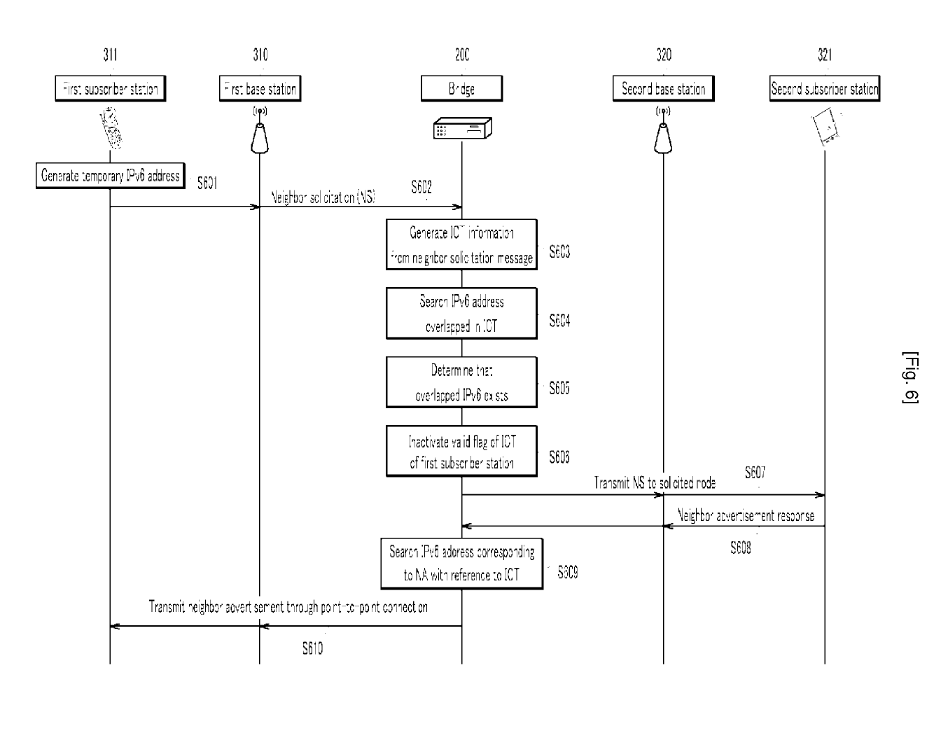

A method for generating ICT information by the bridge in the wireless communication system according to the exemplary embodiment of the present invention will now be described with reference to FIG. 5.

FIG. 5 is a flowchart for generating the ICT information with the NS message for the DAD transmitted from the subscriber station according to the exemplary embodiment of the present invention.

Referring to FIG. 5, according to the [RFC2462] standard, the first subscriber station 311 derives a Tentative IPv6 address from assigned network prefix information and its MAC address in step S501. To verify the validity of the derived Tentative IPv6 address, the first subscriber station 311 adds the Tentative IPv6 address to a Target Address field in a NS message for the DAD, defined in the [RFC2461], and has the NS message destined for the MAC address of the solicited node, and sends the NS message in step S502.

The bridge 200 receives the NS message from the first subscriber station 311, and obtains the MAC address of the first subscriber station 311, and stores the Tentative IPv6 address conveyed in the NS message as IPv6 address information on the first subscriber station in the ICT 210 in step S503.

Then, the bridge 200 determines whether the stored IPv6 address is in duplicate or not, by means of looking for same IPv6 address in ICT 210 (with activated valid flag) as the stored IPv6 address S504, and activates the corresponding valid flag when the stored IPv6 address is not in duplicate, and the NS message is discarded in step S505, S506.

A method for supporting the neighbor discovery operations of the subscriber stations by the bridge in the wireless communication system according to the exemplary embodiment of the present invention will now be described with reference to FIG. 6.

FIG. 6 is a flowchart for supporting the neighbor discovery operations for the DAD in the wireless communication system according to the exemplary embodiment of the present invention.

Referring to FIG. 6, the bridge 200 receives the NS message for DAD from the first subscriber station 311 and creates IPv6 address information on the first subscriber station 311 in the ICT 210 in steps S601 to S603, and as these are the same as the steps S501 to S503 shown in FIG. 5, detailed descriptions thereof will be omitted.

The bridge 200 determines whether the created IPv6 address is in duplicate or not, by means of looking for same IPv6 address in ICT 210 (with activated valid flag) as the created IPv6 address in step S604, and activates the corresponding valid flag when the stored IPv6 address is not in duplicate, and the NS message is discarded in step S506. When it is determined that the created IPv6 address is in duplicate in step S605, the bridge 200 inactivates the valid flag corresponding to the created IPv6 address in step S606, and transmits the NS message to the solicited node in step S607. Assuming that the Tentative IPv6 address of the first subscriber station 311 is used by the second subscriber station 321 on the same link, the NS message is transmitted to the second subscriber station 321 through the second base station 320. In addition, the bridge 200 receives the NA message indicating that the Tentative IPv6 address is currently used from the second subscriber station 321 in response to the NS message in step S608.

The bridge 200 refers to ICT 210 so as to find information on subscriber station which has the inactivated valid flag and IPv6 addresses identical to that in the Target Address field of the received NA message in step S509. The bridge 200 uses identifier for the point-to-point connection assigned to above the found subscriber station in order to transmit the NA message through the point-to-point connection.

In addition, the bridge 200 transmits periodic RA messages from the access router 100 through all the point-to-point connections between the base station 300 and the bridge 200 with reference to the identifier for the point-to-point connections in the ICT 210.

As described above, the bridge 200 support IPv6 network by transmitting messages having link-local scoped all-nodes multicast address as the IP destination address, which is transmitted to all the IPv6 nodes on the same link, through the point-to-point connections.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A bridge in a wireless communication system in which network prefix information is shared, the bridge comprising:
an identification cache table (ICT) having a MAC address of each subscriber station connected to the bridge, an identifier for point-to-point connection between the bridge and each subscriber station, an Internet Protocol (IP) address, and a valid flag value; and
a neighbor discovery relay agent for creating ICT information on a subscriber station based on a neighbor solicitation message for duplicate address detection (DAD) received from the subscriber station, determining whether a created IP address of the subscriber station is in duplicate or not, and determining the valid flag value,
wherein the bridge transmits data having a multicast address, which is transmitted to all nodes on the same link, as a destination address with reference to the ICT.

2. The bridge of claim 1, wherein the neighbor discovery relay agent activates a valid flag when it is determined that the IP address of the subscriber station is unique, otherwise the neighbor discovery relay agent inactivates the valid flag.

3. The bridge of claim 2, wherein the neighbor discovery relay agent transmits a neighbor solicitation message to a solicited node when the valid flag of the subscriber station is inactivated.

4. A wireless communication system having one sub-network, the wireless communication system comprising:
an access router for allocating a common network prefix to all subscriber stations on the same link;
a bridge for transmitting data having a multicast address, which is transmitted to all nodes on the same link, as a destination address with reference to an identification cache table (ICT) having a MAC address of each subscriber station connected to the bridge, an identifier for point-to-point connection between the bridge and each subscriber station, an IP address, and a valid flag value; and
a base station establishing point-to-point connections between the bridge and each subscriber stations.

5. The wireless communication system of claim 4, wherein, when receiving the data having the multicast address, which is transmitted to the all nodes on the same link, as the destination address from the bridge, the access router forwards the data back to the bridge.

6. The wireless communication system of claim 5, wherein when, forwarding the data back to bridge, the access router maintains a same source IP address and a Hop Limit value as those of the data which have received from the bridge.

7. The wireless communication system of claim 5, wherein the base station maintains information of identifiers for wireless link connection and the identifier for the point-to-point connection generated for each subscriber station between the bridge and the base station to establish the point-to-point connections between the subscriber stations and the bridge.

8. A method for supporting neighbor discovery for duplicate address detection by a bridge in a wireless communication system in which network prefix information is shared, the method comprising:
a) receiving a neighbor solicitation message from a first subscriber station;
b) determining whether a temporary IP address of the first subscriber station is in duplicated or not with reference to an identification cache table (ICT) having a MAC address of each subscriber station connected to the bridge, an identifier for point-to-point connection between the bridge and each subscriber station, an IP address, and a valid flag value;
c) inactivating a valid flag of the first subscriber station when it is determined in b) that the IP address is in duplicate, and transmitting a neighbor solicitation message to a solicited node;
d) receiving a neighbor advertisement message from a second subscriber station using the IP address of the first subscriber station; and
e) forwarding the neighbor advertisement message through the point-to-point connection between the first subscriber station and the bridge.

9. The method of claim 8, further comprising f) activating the valid flag and discarding the neighbor solicitation message when it is determined in b) that the IP address of the first subscriber station is not in duplicate.

10. The method of claim 8, wherein b) further comprises:
b-1) generating ICT information of the first subscriber station based on the neighbor solicitation message; and
b-2) searching ICT information having the valid flag activated in the ICT and an IP address that is the same as the temporary IP address of the first subscriber station.

11. The method of claim 8, wherein d) comprises searching ICTP information on subscriber station having the valid flag inactivated in the ICT and an IP address that is the same as an IP address stored in a Target Address field of the received neighbor advertisement message.

12. The method of claim 8, wherein, in e), the neighbor advertisement message is transmitted through the point-to-point connection identified by the ICT information on the first subscriber station searched in d).

13. A method for transmitting router advertisement message by a bridge in a wireless communication system in which network prefix information is shared, the method comprising:
a) receiving the router advertisement message from an access router;
b) searching identifier information for point-to-point connection assigned to each subscriber station from an identification cache table (ICT) having a MAC address of each subscriber station connected to the bridge, an identifier for point-to-point connection between the bridge and each subscriber station, an IP address, and a valid flag value; and
c) transmitting the router advertisement messages to the corresponding subscriber station through the point-to-point connection based on the searched identifier information.

14. The method of claim 13, wherein the ICT information is managed based on a life-time, and information on a subscriber station at a power saving mode in which data are not transmitted and received for a predetermined time is removed.
